(19) United States
(12) Patent Application Publication
(10) Pub. No.: US 2007/0290830 A1
(43) Pub. Date: Dec. 20, 2007

(54) Remotely monitored security system

(75) Inventor: Scott A. Gurley, Austin, TX (US)

Correspondence Address: MEYERTONS, HOOD, KIVLIN, KOWERT & GOETZEL, P.C., P.O. BOX 398, AUSTIN, TX, 78767-0398, US

(73) Assignee: Phase IV Partners, Inc.

(21) Appl. No.: 11/453,646

(22) Filed: Jun. 15, 2006

(51) Int. Cl. G08B 29/00; G08B 1/00

(52) U.S. Cl. 340/506; 340/531

(57) ABSTRACT

A security system and methods are disclosed. The system comprises sensors coupled to an alarm panel, an alarm converter, a virtual monitor, and one or more subscriber devices. A first sensor sends a first signal to the alarm panel in response to detecting an alarm event. In response to receiving the first signal, the alarm panel conveys a second signal. In response to receiving the second signal, the alarm converter transmits a third signal to the virtual monitor. In response to receiving the third signal, the virtual monitor retrieves additional data associated with the alarm event and forwards the retrieved data to a subscriber device. In a further embodiment, the security system comprises one or more data recording devices from which the virtual monitor retrieves the addition data. In a still further embodiment, at least one of the data recording devices is a video camera configured to store video.

### BACKGROUND OF THE INVENTION

1. Field of the Invention

This invention relates to security systems and, in particular, to systems and methods of monitoring premises via internet-connected devices.

2. Description of the Related Art

It has become common to use a variety of electronic devices to provide security and monitoring within and around the home, office, or other premises. In addition to conventional door and window contacts, glass break detectors, motion detectors, smoke and gas detectors, and the like, a variety of compact video cameras are also in use in home security and monitoring applications. Typically, outputs from these devices and sensors are brought together at an alarm control panel located on the premises. Often, the control panel is connected to a telephone line via which a call may be automatically placed to a monitoring service if an alarm event occurs (e.g., burglary or other intrusion). Responsive to receiving notification of an event, a monitoring service may alert law enforcement or other emergency agencies or take other actions depending on the level of service contracted by the security subscriber. For example, the monitoring service may employ a human operator to respond to an alarm event by attempting to place a call to a residential subscriber at home.

Conventional alarm monitoring services provide a limited amount of information to the subscriber after an alarm event. Consequently, it may be difficult to determine the cause of an event, or if an event is a false alarm. If the subscriber is not available on the premises when an event occurs, the subscriber may have to travel to the premises to investigate the cause of the alarm, without knowing the urgency of the situation. Therefore, it may be desirable for a subscriber to receive more detailed information about the alarm and what is happening that may have caused the alarm from a remote location. It may also be desirable for the subscriber to be able to react to an alarm event by changing the configuration of the security system from a remote location.

### SUMMARY OF THE INVENTION

Various embodiments of a security system and methods are disclosed. In one embodiment the security system comprises one or more sensors coupled to an alarm panel, an alarm converter, a virtual monitor, and one or more subscriber devices. A first one of the one or more sensors is configured to send a first signal to the alarm panel in response to detecting an alarm event. In response to receiving the first signal, the alarm panel is configured to convey a second signal. In response to receiving the second signal from the alarm panel, the alarm converter is configured to transmit a third signal to the virtual monitor. In response to receiving the third signal, the virtual monitor is configured to retrieve additional data associated with the alarm event and forward the retrieved data to at least one of the one or more subscriber devices.

In a further embodiment, the security system comprises one or more data recording devices and the additional data associated with the alarm event comprises data from at least one of the one or more data recording devices. In a still further embodiment, each of the one or more data recording devices is configured to transmit and receive internet protocol (IP) packets via a wireless connection to an internet. In a still further embodiment, at least one of the one or more data recording devices is a video camera configured to capture video.

These and other embodiments, variations, and modifications will become apparent upon consideration of the following description and associated drawings.

### BRIEF DESCRIPTION OF THE DRAWINGS

FIG. 1 is a generalized block diagram of one embodiment of a security system.

FIG. 2 is a generalized block diagram of an alternative embodiment of a security system.

FIG. 3 is a generalized block diagram of a further embodiment of a security system.

FIG. 4 is a sequence diagram illustrating one embodiment of signals communicated within a security system.

FIG. 5 illustrates one embodiment of a configuration window of a web-based alarm management system that may be used to configure devices in a security system.

FIG. 6 illustrates one embodiment of a configuration window of a web-based alarm management system that may be used to configure sensors in a security system.

FIG. 7 illustrates one embodiment of a configuration window of a web-based alarm management system that may be used to configure subscriber reporting devices in a security system.

FIG. 8 illustrates one embodiment of a method for monitoring a security system from a remote location when an alarm event occurs.

FIG. 9 illustrates one embodiment of a process that may be used to capture and transmit video to a remote location from a camera in a security system when an alarm event occurs.

### DETAILED DESCRIPTION

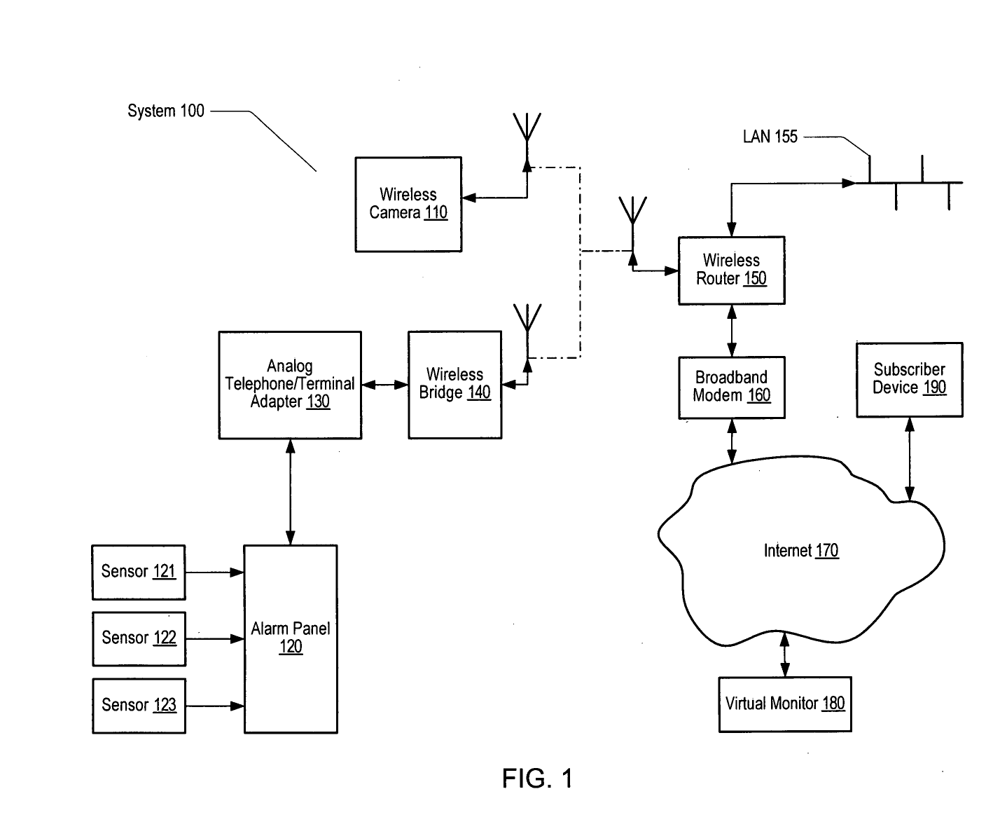

FIG. 1 is a generalized block diagram of one embodiment of a security system 100. For purposes of discussion, the systems and methods will be described within the confines of a home. However, those skilled in the art will appreciate the systems and methods may be used in association with any premises. The illustrated system includes a wireless camera 110 and an alarm panel 120. In one embodiment, sensors 121-123 may be coupled to alarm panel 120. Sensors 121-123 may be any of a variety of devices including door and window contacts, glass break detectors, motion detectors, smoke and gas detectors, “latchkey” tags, or any other suitable device. In alternative embodiments, one or more sensors may further be coupled to or incorporated into devices such as wireless camera 110. Further, one or more of the devices may have wireless, power line, or other communication mechanisms built into the device. Alarm panel 120 may be further coupled to an analog to digital conversion device, such as an analog telephone/terminal adapter (ATA) 130, which in turn may be coupled to a wireless bridge 140. System 100 may also include a wireless router 150 coupled to a local area network (LAN) 155 and a modem 160. While the illustrated embodiment depicts a wireless camera 110, a wireless bridge 140, and a wireless router 150, other embodiments may utilize wired devices, or any suitable combination of wired and wireless devices. In some embodiments, one or more of the components may be configured to receive a “dongle” or other device which then enables the component to communicate via wireless means. For example, camera 110 may include one or more ports (e.g., Ethernet, General Purpose I/O, etc.) to which a wireless adapter may be coupled. Numerous such embodiments are possible and are contemplated. In one embodiment, modem 160 comprises a broadband modem which is connected to the Internet 170. Also shown are a virtual monitor 180 and a subscriber device 190 coupled to the Internet 170.

LAN 155, wireless router 150, and broadband modem 160 may be configured as a conventional LAN interconnecting a variety of computing and entertainment devices as well as providing connectivity from these devices to the Internet. For instance, in one embodiment, LAN 155 may interconnect desktop computers, laptop computers, game systems, and so on. Alternatively, wireless router 150 may have wireless ports and/or wired ports to which the aforementioned devices may be connected. Virtual monitor 180 and subscriber device 190, also being connected to the Internet 170, may be configured to communicate with any of the devices on LAN 155. In one embodiment, virtual monitor 180 and subscriber device 190 may be located remote from the subscriber premises. In alternative embodiments, either or both of the virtual monitor 180 and subscriber device 190 may be located on the subscriber premises. For example, virtual monitor 180 may comprise hardware, firmware, software, or any combination of the above and may be included within one or more of wireless camera 110, wireless bridge 140, wireless router 150, or another device within the subscriber premises. Subscriber device 190 may be a mobile phone, personal digital assistant (PDA), or other mobile device that the subscriber may carry from the premises to a remote location.

Wireless camera 110 may also communicate with internet-connected devices via a wireless connection to wireless router 150. Similarly, wireless bridge 140 may communicate with internet-connected devices via another wireless connection to wireless router 150. In one embodiment, the devices of system 100 may communicate via an internet protocol (IP) compatible wireless protocol (e.g., Wi-Fi). However, in alternative embodiments, other protocols may be used between devices and within the system such as Bluetooth wireless technology, power line communication (PLC), broadband over power line (BPL), or a combination of protocols. Although system 100 as shown includes three sensors and one wireless camera, it will be clear to one of ordinary skill in the art that various embodiments of system 100 may include any number of sensors and/or more than one wireless camera for detecting and monitoring additional points or zones in the home.

During operation, any of sensors 121-123 may detect an alarm event and send a signal to alarm panel 120. In a conventional security system, alarm panel 120 would respond to a signal from a sensor by activating an alarm and/or initiating a telephone call to a monitoring service center via an analog phone line. In the illustrated embodiment, ATA 130 may be configured to intercept calls from alarm panel 120. Upon detecting a call from alarm panel 120, ATA 130 may return a handshake signal, to which alarm panel 120 may respond by sending a signal including information such as an account code, the alarm type, or any other suitable information. ATA 130 may then interpret the signal from alarm panel 120 and convert it to a format suitable for transmission via the Internet. For example, the contents of the alarm panel signal may be converted to text, placed within one or more communication packets, and sent via IP through wireless bridge 140, wireless router 150, broadband modem 160, and the Internet 170 to virtual monitor 180. In embodiments where virtual monitor 180 is located within the home, the communication packets may not initially traverse the Internet.

Upon receiving a communication packet(s) from the subscribers home, virtual monitor 180 may decode the packet(s) to determine the origin of the communication (e.g., an identification of the associated subscriber/ATA) and the nature of the alarm event. In one embodiment, virtual monitor 180 may then respond to the received packet(s) by sending a reply signal back to ATA 130. ATA 130 may then respond to the reply signal by sending a signal to alarm panel 120, which causes it to terminate the alarm event signal and the telephone call. In addition, virtual monitor 180 may then contact the subscriber via a method pre-selected by the subscriber. It is noted that existing conventional monitoring services may receive alarm event communications conforming to one of multiple formats and/or protocols. Upon determining which of the multiple formats is used, the communication may then be routed to a predetermined application which is configured to process communications in the corresponding format. Information concerning the account number, alarm code, subscriber, etc. may then be, determined. In various embodiments of the present system, a more uniform approach to reporting alarm events may be utilized wherein information may be conveyed as text. Responsive to receiving an alarm event communication, virtual monitor 180 may then process the text encoded data.

Due to the wide assortment of devices through which subscribers may connect to the Internet, there are numerous ways virtual monitor 180 may contact the subscriber. For example, a subscriber may wish to be contacted through subscriber device 190, which may be any of a desktop computer, a laptop computer, a cellular telephone, a PDA, a handheld computer, etc. Virtual monitor 180 may send a message to one or more of the subscriber's pre-selected devices via e-mail, text messages, or otherwise according to subscriber preference. In one embodiment, virtual monitor 180 may also retrieve and forward video from one or more wireless cameras 110 to subscriber device 190 upon receiving an alarm event signal. In addition, virtual monitor 180 may be configured to store video for later review by the subscriber. Generally speaking, management of captured audio/video may be performed at the monitored premises (e.g., router may include such functionality), at virtual monitor 180, at an alarm monitoring service, or any other suitable location. For example, audio/video could be forwarded to an alarm monitoring service where it is reviewed in response to an alarm event. Based upon their review, the service may be able to provide additional details concerning the event to a customer. System 100 may format video using any of a variety of formats depending on the desired image quality and the degree of compression that is appropriate for the available bandwidth between wireless camera 110 and subscriber device 190. In one embodiment, system 100 may format video according to an MPEG standard or any other suitable encoding standard.

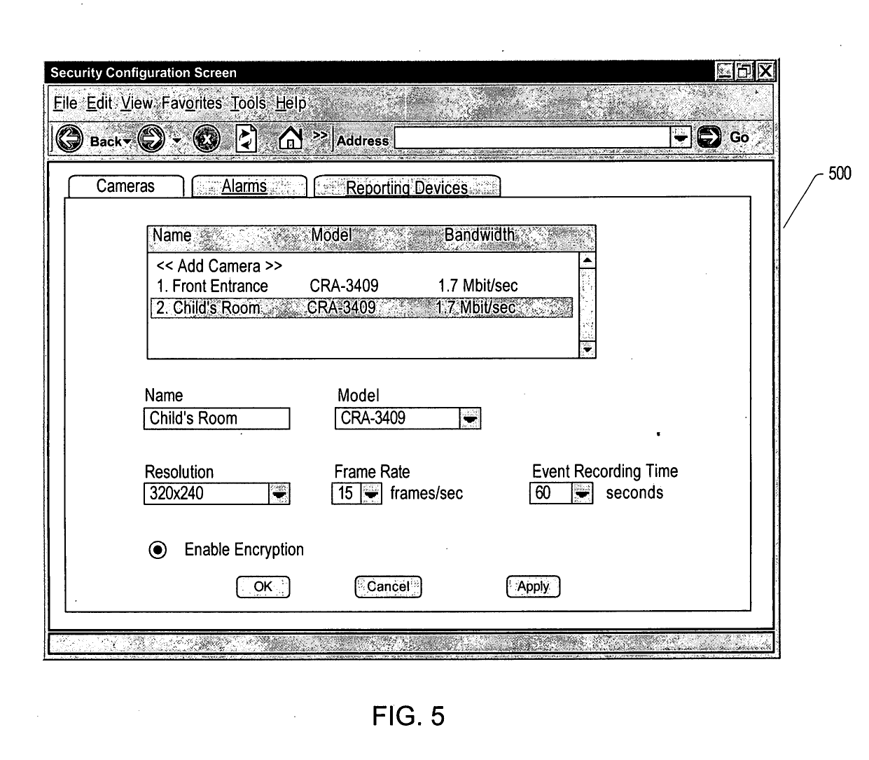

Once a subscriber has been notified of an alarm event, the subscriber may respond in any manner desired. In one embodiment, the subscriber may log into a web-based alarm management system provided by virtual monitor 180. Through the web-based alarm management system, the subscriber may configure home security system 100 in a variety of ways such as selecting one or more cameras from which to receive video, changing preferences, and updating account information. Additionally, the web-based alarm management system may provide further information to the subscriber concerning the alarm event. In one embodiment, the subscriber may trigger one or more wireless cameras 110 to begin recording data, and/or storing data, through the web-based alarm management system. Wireless camera 110 may, for example, be configured to record video in a circular buffer until it receives a trigger signal. Upon receipt of a trigger signal (e.g., from an alarm event or initiated by a subscriber), wireless camera 110 may transfer a portion of pre-recorded video as well as video captured subsequent to the trigger. For example, in one embodiment, after receiving the trigger signal, wireless camera 100 may transfer video captured during the previous one minute followed by video captured after receipt of the trigger signal. Camera 110 may include removable and/or non-removable media for storing recorded data (e.g., flash memory). In addition, the subscriber may adjust various wireless camera settings including pan and tilt through the web-based alarm management system. Further details of a web-based alarm management system interface are provided below in the discussion accompanying FIGS. 5-7. In other embodiments, camera 110 may be configured to stream data which is then captured and managed by a different device. For example, in one embodiment, camera 110 may stream data to router 150 which then stores the received data. Subsequently, the router may receive commands (e.g., from another device on the premises, from an alarm monitoring service, from a subscriber device 190) to convey stored data to another location.

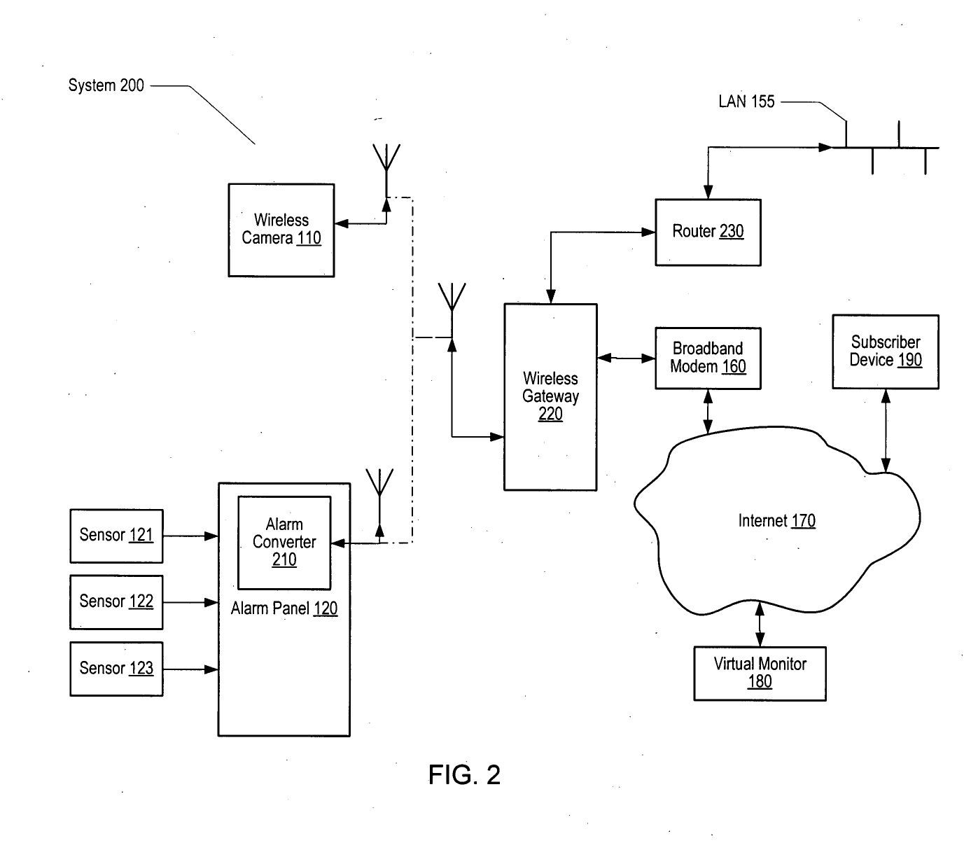

Turning now to FIG. 2, a generalized block diagram of an alternative embodiment of a home security system 200 is shown. The illustrated system includes a wireless camera 110 and an alarm panel 120. As before, sensors 121-123 may be coupled to alarm panel 120. In this embodiment, alarm panel 120 may include a wireless alarm IP converter 210. System 100 may also include a wireless gateway 220 coupled to a broadband modem 160. System 200 may also include a local area network (LAN) 155 couple to a router 230, which in turn may be coupled to wireless gateway 220. Broadband modem 160 may connect to the Internet 170, which may also connect to a virtual monitor 180 and a subscriber device 190.

In a conventional home LAN, LAN 155 may connect to router 230, which may connect to broadband modem 160. Wireless gateway 220 may be inserted between router 230 and broadband modem 160 providing pass-through of packets from LAN 155 to broadband modem 160 as well as connectivity between wireless gateway 220 and the Internet 170. LAN 155 may be configured to operate as described in system 100 above. Although shown with wired ports only, in various alternative embodiments, router 230 may have wireless ports and/or wired ports. Virtual monitor 180 and subscriber device 190 may operate as described in system 100 above. Wireless camera 110 may communicate with internet-connected devices via a wireless connection to wireless gateway 220. Similarly, wireless alarm EP converter 210 may communicate with internet-connected devices via another wireless connection to wireless gateway 220. Although system 200 as shown includes three sensors and one wireless IP camera, it will be clear to one of ordinary skill in the art that various embodiments of system 200 may include any number of sensors and/or more than one wireless IP camera for detecting and monitoring additional points or zones in the home.

During operation, any of sensors 121-123 may detect an alarm event and send a signal to alarm panel 120. As described above, in a conventional security system alarm panel 120 may respond by activating an alarm and/or initiating a telephone call to a monitoring service center via an analog phone line. In the illustrated embodiment, wireless alarm IP converter 210 has been inserted into alarm panel 120 and may be configured to intercept calls from alarm panel 120. Upon detecting a call from alarm panel 120, wireless alarm IP converter 210 may return a handshake signal, to which alarm panel 120 may respond by sending a signal including information such as an account code and the alarm type, using a pre-determined format. Wireless alarm IP converter 210 may interpret the signal from alarm panel 120 and convert it to a format suitable for transmission through the Internet. For example, the contents of the alarm panel signal may be converted to text, place inside a packet, and sent via IP through wireless gateway 220, broadband modem 160, and the Internet 170 to virtual monitor 180. It is to be understood that while converter 210 is referred to herein as an “IP” converter, it may not convert directly to an IP format or protocol. In other embodiments wherein other protocols are used, the converter 210 may perform alternative conversions. Still further, in embodiments wherein IP is part of the system, converter 210 may be configured to perform an intermediate conversion and leave further conversions to other components. Numerous such embodiments are possible and are contemplated. Virtual monitor 180 may respond to received packet(s) by sending a reply signal back to wireless alarm IP converter 210. Wireless alarm IP converter 210 may then respond to the reply signal by sending a signal to alarm panel 120, which causes it to terminate the alarm event signal and the telephone call. In addition, virtual monitor 180 may then contact the subscriber via a method pre-selected by the subscriber. Virtual monitor 180 may contact the subscriber, handle transmission of video, and provide a web-based alarm management system in a manner similar to that described above.

In a typical home security installation, alarm panel 120 may be located in a closet or other similar space in which there may not be electrical outlets. In order to avoid having to route power to wireless alarm IP converter 210, wireless alarm IP converter 210 may be configured to operate on battery power. In one embodiment, IP converter 210 is packaged together with a battery in such a way that it replaces the conventional battery typically used in an alarm panel. For example, wireless alarm IP converter 210 may be manufactured so that both it and the attached battery fit within the same space as the original alarm panel battery. In such an embodiment, the battery which may generally be recharged by the alarm panel may serve as an uninterruptible power source for the converter 210. Further, converter 210 may be supplied without a battery. In such an embodiment, the converter 210 may be supplied with a wiring harness including terminals (e.g., spade lugs) suitable for attaching a customer's existing battery to the supplied converter 210. It is noted that the methods and mechanisms described herein may also serve as an adjunct to an existing security installation. For example, where a customer already has an alarm monitoring service which receives indications via POTS, the methods and mechanism described herein may retain such functionality, but also add one or more of the various features as described herein.

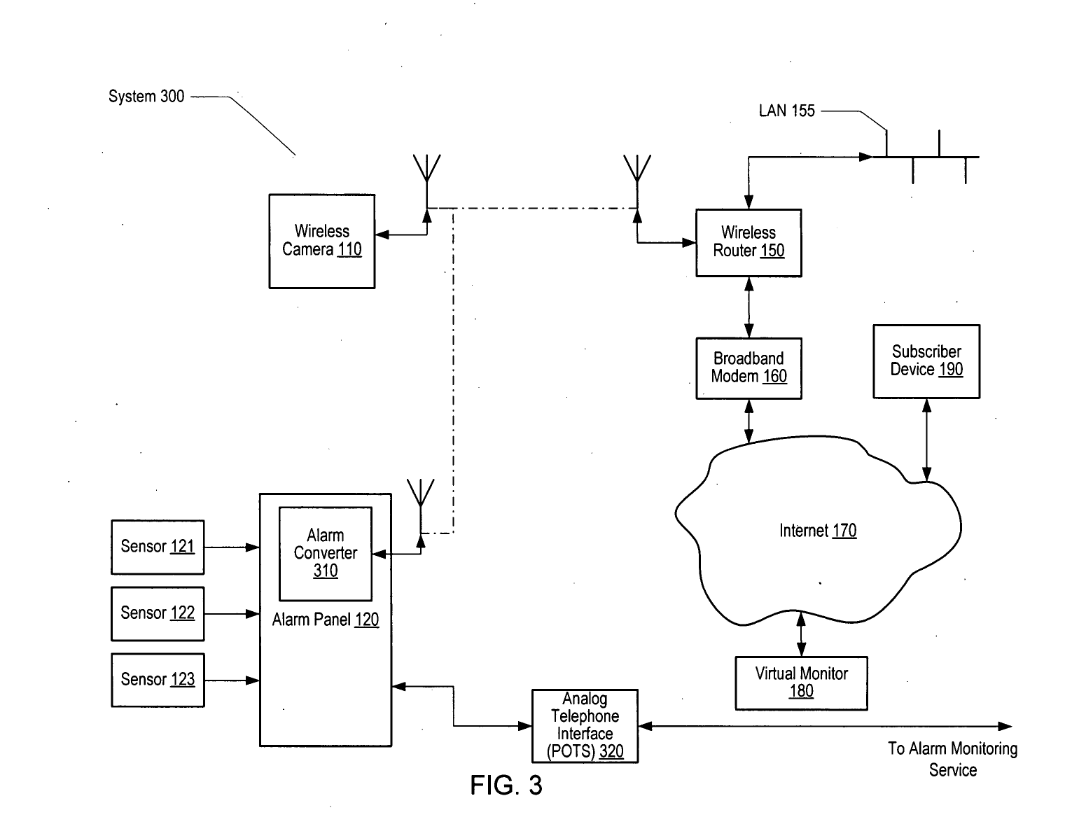

FIG. 3 is a generalized block diagram of a further alternative embodiment of a home security system 300. The illustrated system includes a wireless camera 110 and an alarm panel 120. As before, sensors 121-123 may be coupled to alarm panel 120. In this embodiment, alarm panel 120 may include a wireless alarm IP converter 310. System 300 may also include an analog telephony interface 320 (also know as plain-old telephone service (POTS)) connecting alarm panel 120 to an alarm monitoring service via the public switched telephone network. System 300 may further include a local area network (LAN) 155 couple to a wireless router 150, which in turn may be coupled to a broadband modem 160. Broadband modem 160 may connect to the Internet 170, which may also connect to a virtual monitor 180 and a subscriber device 190.

In a conventional home LAN, LAN 155 may connect to wireless router 150, which may connect to broadband modem 160. LAN 155 and wireless router 150 may be configured to operate as described in system 100 above. Virtual monitor 180 and subscriber device 190 may operate as described in system 100 above. Wireless camera 110 may communicate with internet-connected devices via a wireless connection to wireless router 150. Similarly, wireless alarm IP converter 310 may communicate with internet-connected devices via another wireless connection to wireless router 150. Although system 300 as shown includes three sensors and one wireless IP camera, it will be clear to one of ordinary skill in the art that various embodiments of system 300 may include any number of sensors and/or more than one wireless IP camera for detecting and monitoring additional points or zones in the home.

During operation, any of sensors 121-123 may detect an alarm event and send a signal to alarm panel 120. Alarm panel 120 may respond to a signal from a sensor by activating an alarm and/or initiating a telephone call to a monitoring service center via analog telephony interface 320. The monitoring service may respond to the alarm by sending a signal back to alarm panel 120. Alarm panel 120 may respond to the signal by terminating the alarm event signal and hanging up the telephone call. In one embodiment, alarm panel 120 may optionally be configured with a wireless alarm IP converter 310 that intercepts calls from alarm panel 120 in the same manner as wireless alarm IP converter 210 of system 200.

Virtual monitor 180 may be configured to receive packets from one or more wireless alarm IP converters via the Internet 170. Upon receiving a packet from wireless alarm IP converter 310, virtual monitor 180 may also decode the packet to determine which wireless alarm IP converter sent the packet and the nature of the alarm event. From the identification of the wireless alarm IP converter, virtual monitor 180 may determine the identity of the associated subscriber. Virtual monitor 180 may then respond to the received packet(s) by sending a reply signal back to wireless alarm IP converter 310. Wireless alarm IP converter 310 may respond to the reply signal by sending a signal to alarm panel 120, which causes it to terminate the alarm event signal and the telephone call. In addition, virtual monitor 180 may then contact the subscriber via a method pre-selected by the subscriber.

In one embodiment, in addition to the functions described above, wireless alarm IP converter 310 may send a trigger to one or more wireless cameras upon receiving an alarm event signal from alarm panel 120. The wireless cameras may respond to a trigger in the same manner as if the trigger had been sent from the subscriber through virtual monitor 180—sending video through wireless router 150, broadband modem 160, and the Internet 170. It is noted that in alternative embodiments, at least some of the described functionality of converter 310 may be incorporated into router 150. For example, rather than converter 310 conveying a signal directly to a wireless camera 110, converter 310 may convey a signal to router 150 which then conveys a triggering signal to camera 110. Further, communications which trigger camera 110 may comprise HTML code, or any other predetermined data.

Systems 100, 200, and 300 represent a small subset of the possible embodiments of the invention. The number of components added to a conventional home security system may include ATA 130, wireless bridge 140, wireless alarm IP converter 210, wireless gateway 220, or wireless IP converter 310 of system 300. The flexibility provided by various embodiments of these alarm IP converter systems allows them to be marketed directly to subscribers as after-market enhancements to existing home security systems and/or to alarm companies for resale to subscribers, depending on the chosen configuration. For example, in various embodiments, a customer need only have an existing alarm system capable of reporting alarm events (e.g., via POTS or otherwise), and broadband access.

In addition to the above, virtual monitor 180, an alarm monitoring service, or otherwise, may be configured to periodically monitor the broadband modem 160, router 150, and/or some other device within a customer's premises. Should communication with the monitored device(s) be lost, a notification may be provided to the customer. Communication could be lost due to a defective device, loss of broadband connectivity, and so on. In this manner, the customer may be alerted that their security system may be unable to convey alerts. Periodic monitoring of the device(s) could be performed via heartbeat or any other suitable technique. It is noted that various components within the home could also be configured to monitor one another. So, for example, should the alarm panel fail, converter 310 or router 150 could detect such a failure and convey a notification as described above.

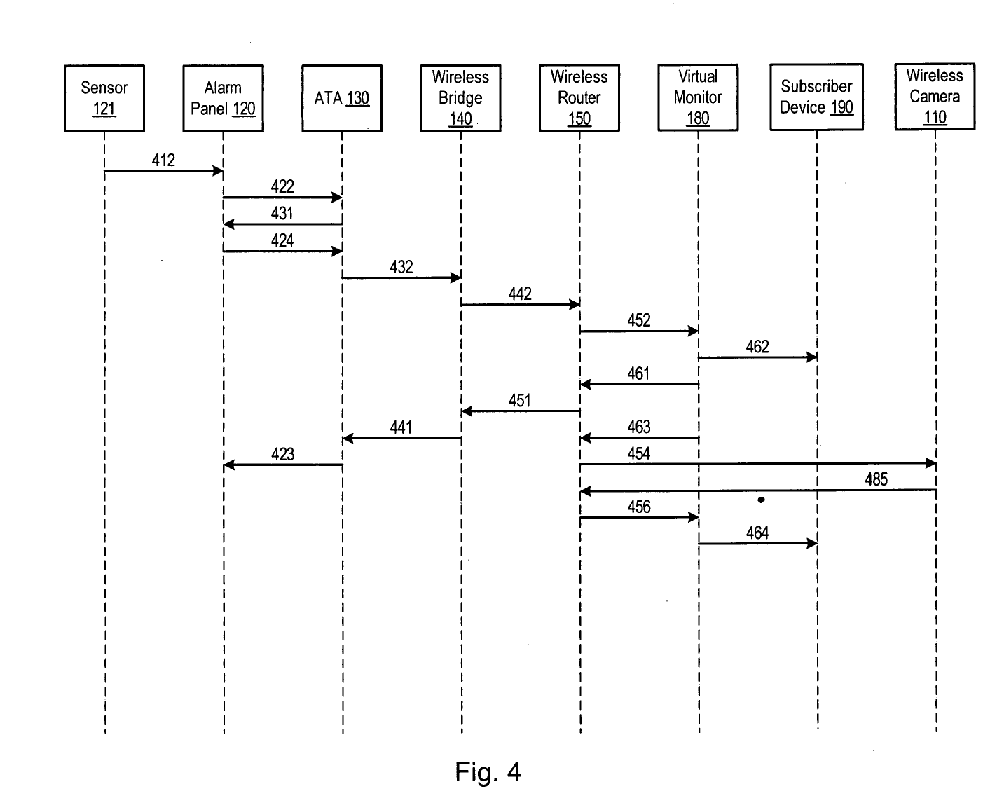

Turning now to FIG. 4, a sequence diagram is shown illustrating one embodiment of the signals communicated within system 100 in response to an alarm event. For convenience it will be assumed that sensor 121 detects an alarm event and that the subscriber has configured the system to respond to such an event by retrieving video from wireless camera 110. Similar sequence diagrams in which other sensors detect alarm events, other cameras retrieve video, and/or that apply to systems 200 or 300 will be apparent to those skilled in the art given the following description.

Sensor 121 may respond to the detection of an alarm event by transmitting a signal 412 to alarm panel 120. Alarm panel 120 may respond to signal 412 by placing a telephone call 422. ATA 130 may intercept call 422 and respond to it by sending a handshake 431 back to alarm panel 120. Alarm panel 120 may respond to handshake 431 by sending a signal 424 including information such as an account code and the alarm type. ATA 130 may interpret signal 424 and convert it to a packetized signal 432 suitable for transmission over IP. Wireless bridge 140 may receive signal 432 and forward a corresponding signal 442 to wireless router 150. Wireless router 150 may receive signal 442 and forward a corresponding signal 452 to virtual monitor 180. Virtual monitor 180 may receive signal 452 and forward a corresponding signal 462 to subscriber device 190. Virtual monitor 180 may also send a signal 461 back to wireless router 150 acknowledging receipt of the alarm event information. Wireless router 150 may respond to signal 461 by sending a corresponding signal 451 to wireless bridge 140. Wireless bridge 140 may respond to signal 451 by sending a corresponding signal 441 to ATA 130. ATA 130 may respond to signal 441 by sending a signal 423 to alarm panel 120, which causes it to terminate the alarm event signal and the telephone call. In addition to the above, router 150 may be configured to convey alarm signal information directly to a receiver at an alarm monitoring service, to a subscriber device 190, to virtual monitor 180, or any combination of the above.

Virtual monitor 180, in addition to sending signal 461 back to wireless router 150, may send signal 463 containing camera trigger information to wireless router 150. Wireless router 150 may respond to signal 463 by sending a corresponding trigger 454 451 to wireless camera 110. Wireless camera 110 may respond to trigger 454 by sending video 485 to wireless router 150. Wireless router 150 may respond to video 485 by forwarding it as video 456 to virtual monitor 180. Virtual monitor 180 may forward video 456 to subscriber device 190 as video 464. In an alternative embodiment, wireless router 150 may respond to video 485 by forwarding it as video 456 directly to subscriber device 190, bypassing virtual monitor 180. In various embodiments, the system may be configured to trigger a particular camera depending upon which sensor detected an alarm event. For example, if a sensor near a backdoor of a home detects an event, only cameras near that location may be triggered. In alternative embodiments, the cameras themselves would detect motion in their viewing area and the presence or absence of motion may be used to determine the appropriate recording to be forwarded or all cameras may be triggered responsive to a sensor event. All such alternatives are contemplated.

FIG. 5 illustrates one embodiment of a configuration window 500 of a web-based alarm management system that may be used to configure various aspects of the security system. Configuration window 500 may include the standard features of a web browser window such as drop-down menus, a navigation bar, and an address field. Within the browser window are shown three tabs labeled “Cameras”, “Alarms”, and “Reporting Devices”. In alternative embodiments, additional tabs may be included, such as a tab from which a subscriber may configure the operation of the security system. For example, a subscriber may define the behavior of the security system in general and the virtual monitor in particular according to one or more rules which associate an event with a corresponding action.

As illustrated in FIG. 5, the Cameras tab is selected. On the Cameras tab, the subscriber may be presented with a number of user input items. A scrollable selection box is shown near the top of the Cameras tab from which the subscriber may choose which of a list of cameras to configure or choose to add a camera to the system. In the illustration, camera 2 is selected. The name, model number, and bandwidth capability of Camera 2 are shown in the scrollable selection box. The name of the selected camera, “Child's Room”, also appears in an input field, where the subscriber may change it. The model designation of camera 2 appears in a drop-down list box where it may also be changed by the subscriber. The subscriber may also change the resolution, frame rate, and event recording time of the selected camera through a row of drop-down list boxes. The values in the drop-down lists for model, resolution, frame rate, and event recording time may be pre-populated by the web-based alarm management system with values support by the home security system. For example, for the camera selected in the illustration, the model is “CRA-3409”, the resolution is 320×240 pixels, the frame rate is 15 frames per second, and the event recording time is sixty seconds. The subscriber may also choose to enable encryption for the selected camera by checking a radio button. Once the subscriber has completed the desired configuration settings he or she may click on either an OK button or an Apply button to transmit the selections to the home security system. If the subscriber does not wish to save the configuration settings he or she may click on a Cancel button.

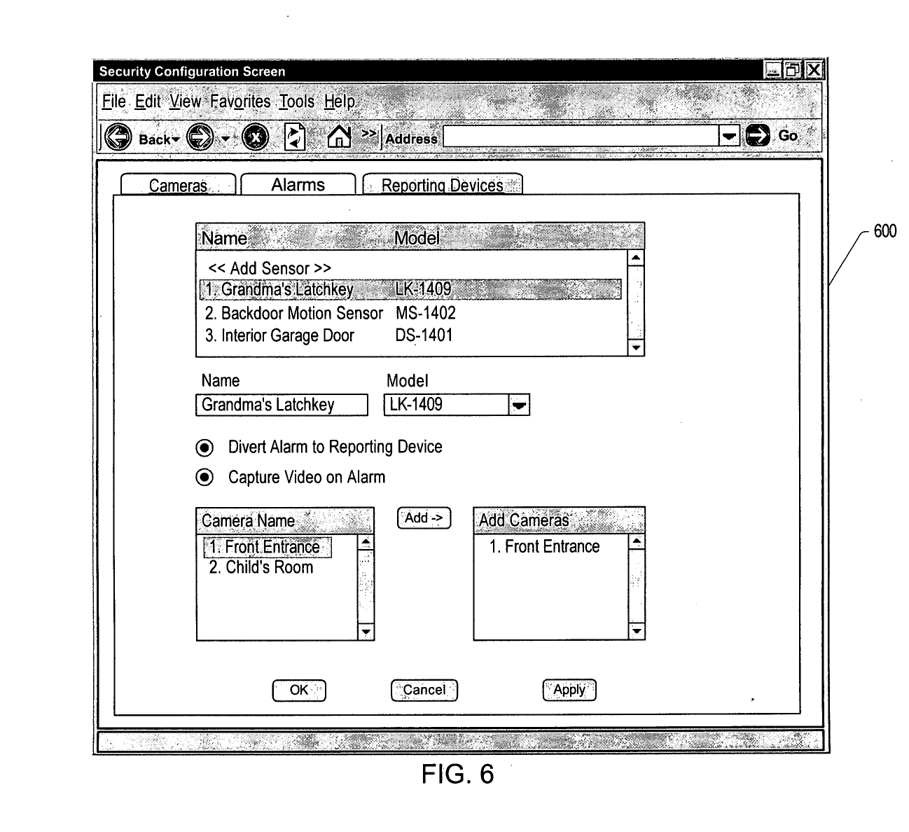

FIG. 6 illustrates one embodiment of a configuration window 600 of a web-based alarm management system that may be used to configure sensors in a home security system. As illustrated in FIG. 6, the Alarms tab is selected. On the Alarms tab, the subscriber may be presented with a number of user input items. A scrollable selection box is shown near the top of the Alarms tab from which the subscriber may choose which of a list of sensors to configure or choose to add a sensor to the system. In the illustration, sensor 1 is selected. The name and model number of sensor 1 are shown in the scrollable selection box. The name of the selected sensor, “Grandma's Latchkey”, also appears in an input field, where the subscriber may change it. The model designation of sensor 1 appears in a drop-down list box where it may also be changed by the subscriber. The model drop-down list may be pre-populated by the web-based alarm management system with values support by the home security system. For example, for the sensor selected in the illustration, the model is “LK-1409.” The subscriber may also choose whether or not to receive a notification of an alarm event from the selected sensor by checking a radio button labeled “Divert Alarm to Reporting Device.” Generally speaking, a latchkey tag may comprise a small device (e.g., suitable for attaching to a key chain, wearing around the neck, etc.) that communicates a wireless signals to a receiving device. If the receiving device detects a signal is no longer being received from the latchkey tag, the receiving device may convey an alert to a monitoring service, virtual monitor, subscriber device or otherwise. Alternatively, the receiver may be configured to detect when a latchkey tag comes within range of the receiver. For example, the wireless router, alarm converter, or other device within a premises may be configured to detect the presence and/or absence of a latchkey tag. Such a latchkey tag could be carried by a child (e.g., on a chain, in a backpack, or even in a car) and it would alert you to when they come within range of the receiving device. Alternatively, you could be alerted when they are out of range. The system may further be configured to handle such alerts in a different manner depending upon the time of day. For example, a different alert procedure may be established between the hours of 11:00 p.m. and 7:00 a.m., than during the day. Numerous such embodiments are possible and are contemplated.

The subscriber may also choose whether or not to capture video from one or more cameras if an alarm event comes from the selected sensor by checking a radio button labeled “Capture Video on Alarm.” If the subscriber chooses to capture video a pair of scrollable lists boxes is provided. The subscriber may select a camera from the left list box and click an Add ->button to add the selected camera to the right list box. For example, in the illustration, a camera named “Front Entrance” has been selected and added to the right list box. After the subscriber's selections are saved, if an alarm event comes from the selected sensor, video from the cameras that were listed in the right list box may be captured and sent to the subscriber's chosen reporting device(s).

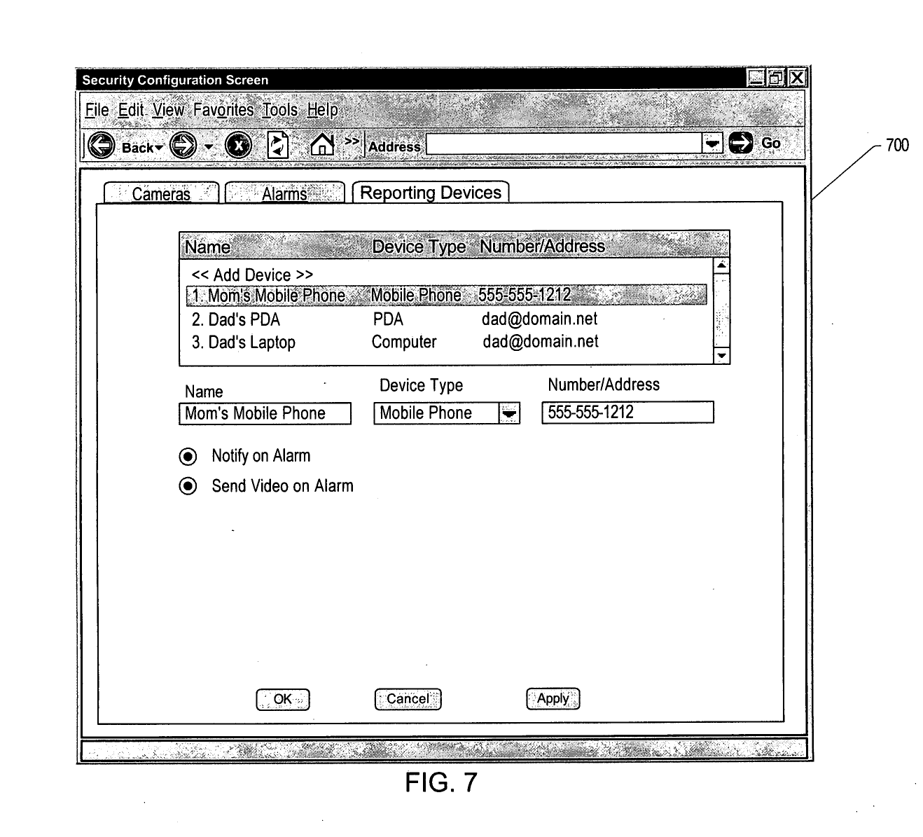

FIG. 7 illustrates one embodiment of a configuration window 700 of a web-based alarm management system that may be used to configure subscriber reporting devices in a home security system. As illustrated in FIG. 7, the Reporting Devices tab is selected. On the Reporting Devices tab, the subscriber may be presented with a number of user input items. A scrollable selection box is shown near the top of the Reporting Devices tab from which the subscriber may choose which of a list of reporting devices to configure or choose to add a reporting device to the system. In the illustration, reporting device 1 is selected. The name, device type, and number/address of reporting device 1 are shown in the scrollable selection box. The name of the selected reporting device, “Mom's Mobile Phone”, also appears in an input field, where the subscriber may change it. The device type of reporting device 1 appears in a drop-down list box where it may also be changed by the subscriber. The device type drop-down list may be pre-populated by the web-based alarm management system with values support by the home security system. For example, for the reporting device selected in the illustration, the device type is “Mobile Phone.” The number or address of the selected reporting device, “Mom's Mobile Phone”, also appears in an input field, where it may be changed by the subscriber. The subscriber may also choose whether or not to receive a notification of an alarm event on the selected reporting device by checking a radio button labeled “Notify on Alarm.” The subscriber may also choose whether or not to receive video from one or more selected cameras on the selected reporting device by checking a radio button labeled “Send Video on Alarm.” As may be appreciated, the embodiments of FIGS. 5-7 are intended to be exemplary only. Numerous configurations for such an interface are possible and are contemplated.

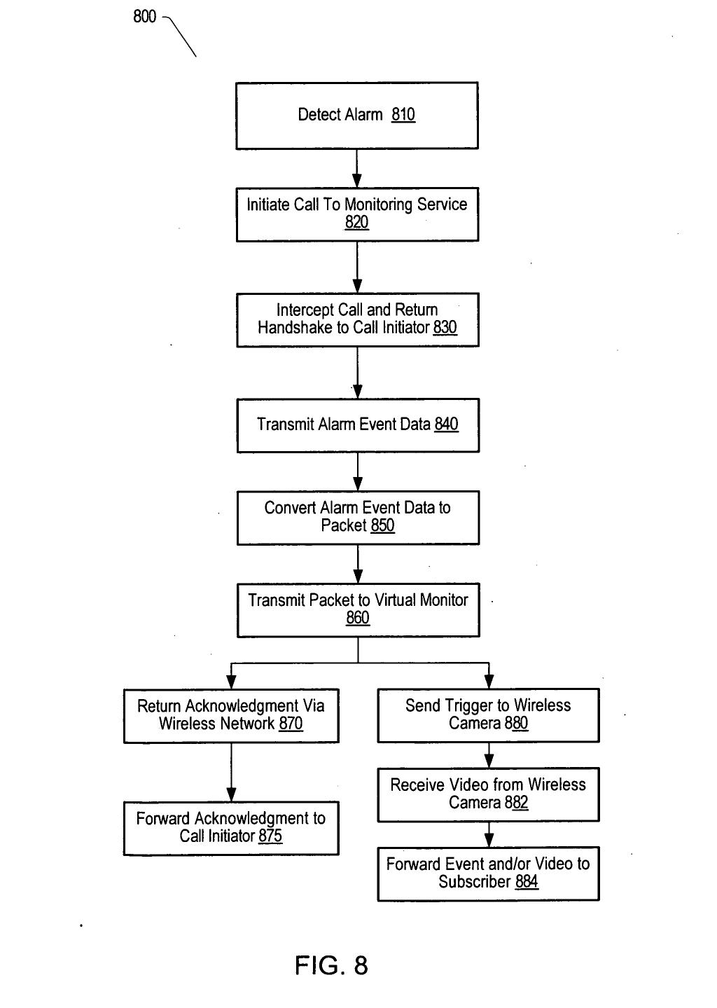

FIG. 8 illustrates one embodiment of a process 800 that may be used to monitor a home security system from a remote location when an alarm event occurs. When an alarm event is detected (block 810), a call may be initiated to a monitoring service (block 820). The call may be intercepted and a handshake signal sent to the call initiator (block 830). Upon receiving the handshake signal, the call initiator may send data describing the alarm event (block 840). The data describing the alarm event may be received and converted to a data packet (block 850). The data packet may then be transmitted to a virtual monitor (block 860) via a wireless connection.

The virtual monitor may return an acknowledgment via the wireless connection (block 870). The acknowledgment may be forwarded to the call initiator (block 875). In addition, the virtual monitor may trigger a camera to capture video related to the alarm event via a wireless connection (block 880). The virtual monitor may receive the captured video (block 882) and forward it, along with alarm event information from the data packet, to the subscriber (block 884).

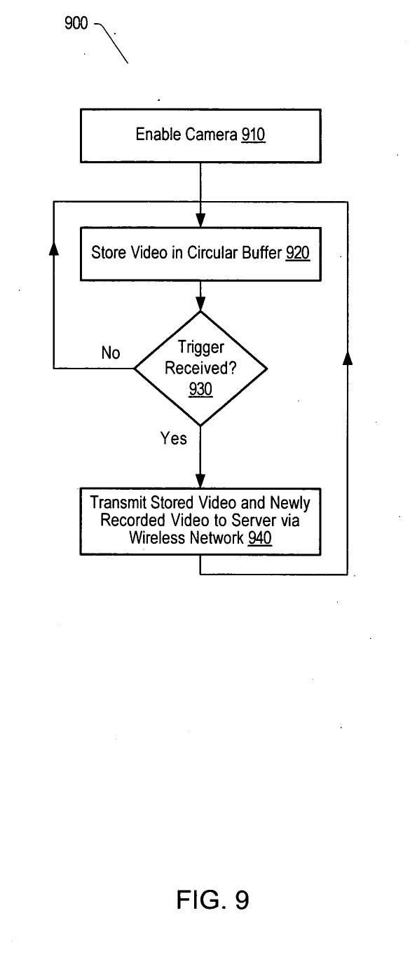

FIG. 9 illustrates one embodiment of a process 900 that may be used to capture and transmit video to a remote location from a camera in a home security system when an alarm event occurs. A camera may be initialized when the home security system is enabled (block 910). Once the camera is initialized, it may store video in a circular buffer (block 920) so that there is always a buffer's worth of video available prior to any alarm event. If a trigger is received (decision block 930), the camera may transmit the video stored in the buffer and newly recorded video from the time of the trigger forward via a wireless connection (block 940). If no trigger is received, the camera may continue to store video in the circular buffer.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A security system comprising:
one or more sensors coupled to an alarm panel;
an alarm converter;
a virtual monitor; and
one or more subscriber devices;
wherein in response to detecting an alarm event, a first sensor of the sensors is configured to convey a first signal to the alarm panel;
wherein the alarm panel is configured to convey a second signal responsive to the first signal;
wherein the alarm converter is configured to transmit a third signal responsive to the second signal; and
the virtual monitor is configured to cause data associated with the alarm event to be conveyed to at least one of the one or more subscriber devices, in response to the third signal.

2. The system of claim 1, further comprising one or more data recording devices, wherein the data associated with the alarm event comprises data from at least one of the one or more data recording devices.

3. The system of claim 2, wherein each of the one or more data recording devices is configured to transmit and receive internet protocol (IP) packets via a wireless connection to an internet.

4. The system of claim 2, wherein at least one of the one or more data recording devices is a video camera.

5. The system of claim 2, wherein in response to receiving the second signal from the alarm panel, the alarm converter is further configured to cause at least one of the one or more data recording devices to convey data to at least one of the one or more subscriber devices.

6. The system of claim 1, wherein each of the one or more subscriber devices is selected from the group consisting of: a desktop computer, a laptop computer, a cellular telephone, a personal digital assistant (PDA), and a handheld computer.

7. The system of claim 1, wherein the virtual monitor is located either on a subscriber premises or remote from a subscriber premises.

8. The system of claim 1, wherein the alarm converter comprises a wireless interface configured to transmit and receive internet protocol (IP) packets via a wireless connection to an internet.

9. The system of claim 8, wherein the alarm converter further comprises an analog telephone/terminal adapter (ATA) and a wireless bridge.

10. The system of claim 1, wherein the virtual monitor is operable to allow a subscriber to configure the security system.

11. A method of monitoring a security system comprising:
detecting an alarm event;
sending a first signal to an alarm panel in response to detecting the alarm event;
the alarm panel conveying a second signal in response to receiving the first signal;
intercepting the second signal;
transmitting a third signal to a virtual monitor in response to intercepting the second signal; and
the virtual monitor causing data associated with the alarm event to be conveyed to at least one of the one or more subscriber devices, in response to the third signal.

12. The method of claim 11, wherein the data associated with the alarm event comprises data from at least one data recording device.

13. The method of claim 12, wherein the at least one data recording device is configured to transmit and receive internet protocol (IP) packets via a wireless connection to an internet.

14. The method of claim 12, wherein the at least one data recording device is a video camera.

15. The method of claim 12, further comprising causing the at least one data recording device to convey data to at least one subscriber device in response to intercepting the second signal.

16. The method of claim 11, wherein each of the one or more subscriber devices is selected from the group consisting of: a desktop computer, a laptop computer, a cellular telephone, a personal digital assistant (PDA), and a handheld computer.

17. The method of claim 11, wherein the virtual monitor is located either on a subscriber premises or remote from a subscriber premises.

18. The method of claim 11, wherein the second signal is intercepted by an alarm converter comprising a wireless interface configured to transmit and receive internet protocol (IP) packets via a wireless connection to an internet.

19. The method of claim 18, wherein the alarm converter comprises an analog telephone/terminal adapter (ATA) and a wireless bridge.

20. The method of claim 18, wherein the virtual monitor is operable to allow a subscriber to configure the security system.
